(19) United States
(12) Patent Application Publication
(10) Pub. No.: US 2022/0374600 A1
(43) Pub. Date: Nov. 24, 2022

(54) KEYPHRASE GENERATION FOR TEXT SEARCH WITH OPTIMAL INDEXING REGULARIZATION VIA REINFORCEMENT LEARNING

(71) Applicant: NEC Laboratories America, Inc., Princeton, NJ (US)

(72) Inventors: Wei Cheng, Princeton Junction, NJ (US); Haifeng Chen, West Windsor, NJ (US); Xuchao Zhang, Elkridge, MD (US); Dongsheng Luo, State College, PA (US)

(21) Appl. No.: 17/723,994

(22) Filed: Apr. 19, 2022

Related U.S. Application Data
(60) Provisional application No. 63/186,243, filed on May 10, 2021.
(60) Provisional application No. 63/312,531, filed on Feb. 22, 2022.

(51) Int. Cl. G06F 40/289; G06F 40/169; G06F 40/284; G06F 16/34; G06N 3/08

(52) U.S. Cl. CPC G06F 40/289; G06F 40/169; G06F 40/284; G06F 16/345; G06N 3/08

(57) ABSTRACT

A computer-implemented method is provided for keyphrase generation. The method includes pretraining, by a processor device, a policy neural network on training documents using a sequence-to-sequence model. The training documents are each associated with a list of keyphrases included therein. The method further includes training, by the processor device, the policy neural network using reinforcement learning with a summarization reward on present annotated keyphrases in an input training document and absent annotated keyphrase from the input training document that semantically describe a concept of the input training document. The method also includes predicting, by the processor device, new keyphrases using the trained policy neural network.

### RELATED APPLICATION INFORMATION

This application claims priority to U.S. Provisional Patent Application No. 63/186,243, filed on May 10, 2021, and U.S. Provisional Patent Application No. 63/312,531, filed on Feb. 22, 2022, incorporated herein by reference in its entirety.

### BACKGROUND

### Technical Field

The present invention relates to text searching and more particularly to keyphrase generation for text search with optimal indexing regularization via reinforcement learning.

### Description of the Related Art

Keyphrase Generation (KG) is a classical task in natural language processing that aims to summarize a document with a set of keyphrases that capture its main idea. Desired keyphrases are often multi-word units that summarize the high-level meaning and highlight certain important topics or information of the source text. Keyphrases can serve as a condensed summary (e.g., keyphrases of a journal article). They enable the reader to decide quickly whether the given article is interesting or not, such as “snippets”. Keyphrases can be used for browsing, searching, categorizing, classifying, indexing, clustering or managing. High-quality keyphrases can facilitate the understanding, organizing, and accessing of document content. There are many other applications of keyphrases generation. However, existing methods only convey the KG problem from the summarization perspective. Generated keyphrases are suboptimal for indexing and exploring given document corpuses.

### SUMMARY

According to aspects of the present invention, a computer-implemented method is provided for keyphrase generation. The method includes pretraining, by a processor device, a policy neural network on training documents using a sequence-to-sequence model. The training documents are each associated with a list of keyphrases included therein. The method further includes training, by the processor device, the policy neural network using reinforcement learning with a summarization reward on present annotated keyphrases in an input training document and absent annotated keyphrase from the input training document that semantically describe a concept of the input training document. The method also includes predicting, by the processor device, new keyphrases using the trained policy neural network.

According to other aspects of the present invention, a computer program product is provided for keyphrase generation. The computer program product includes a non-transitory computer readable storage medium having program instructions embodied therewith. The program instructions are executable by a computer to cause the computer to perform a method. The method includes pretraining, by a processor device of the computer, a policy neural network on training documents using a sequence-to-sequence model. The training documents are each associated with a list of keyphrases included therein. The method further includes training, by the processor device, the policy neural network using reinforcement learning with a summarization reward on present annotated keyphrases in an input training document and absent annotated keyphrase from the input training document that semantically describe a concept of the input training document. The method also includes predicting, by the processor device, new keyphrases using the trained policy neural network.

According to yet other aspects of the present invention, a computer processing system is provided for keyphrase generation. The computer processing system includes a memory device for storing program code. The computer processing system further includes a processor device, operatively coupled to the memory device, for running the program code to pretrain a policy neural network on training documents using a sequence-to-sequence model. The training documents are each associated with a list of keyphrases included therein. The processor device further runs the program code to train the policy neural network using reinforcement learning with a summarization reward on present annotated keyphrases in an input training document and absent annotated keyphrase from the input training document that semantically describe a concept of the input training document. The processor device also runs the program code to predict new keyphrases using the trained policy neural network.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 is a block diagram showing an exemplary system pipeline, in accordance with an embodiment of the present invention;

FIG. 3 is a table showing an exemplary use case in which a user input a query “apple” and the system returns certain terms, in accordance with an embodiment of the present invention;

FIGS. 4-5 are diagrams showing an exemplary user interface, in accordance with an embodiment of the present invention;

FIG. 6 is a diagram showing exemplary suggested terms for a given query “AI”, in accordance with an embodiment of the present invention;

FIG. 7 is a diagram showing an exemplary Keyphrase Generation (KG) algorithm, in accordance with an embodiment of the present invention;

FIG. 8 is a block diagram showing an exemplary keyphrase generation from a document, in accordance with an embodiment of the present invention;

FIG. 9 is a block diagram showing an exemplary encoder-decoder learning framework, in accordance with an embodiment of the present invention;

FIG. 10 is a block diagram showing an exemplary keyphrase generation procedure 1000, in accordance with an embodiment of the present invention;

FIG. 11 is a block diagram showing an exemplary index keyphrase generation framework, in accordance with an embodiment of the present invention; and

FIGS. 12-13 are flow diagrams showing an exemplary method for keyphrase generation, in accordance with an embodiment of the present invention.

### DETAILED DESCRIPTION OF PREFERRED EMBODIMENTS

Embodiments of the present invention are directed to keyphrase generation for text search with optimal indexing regularization via reinforcement learning.

Embodiments of the present invention provide a methodology to generate keyphrases from documents that well represent the meaning of the document and at the same time well index the document for better information navigation.

Embodiments of the present invention analyze the KG problem under the indexing scenario and present a new reinforcement learning (RL) approach, IndexKG, with an indexing reward function to encourage generating both distinctive and informative keyphrases. The indexing reward is a very good regularizer for learning meaningful representations for both tokens (words) and documents. Also, the indexing reward is very good to learning recessive linguistic patterns between predicted keyphrases and the input documents. Embodiments of the present invention can further include Siamese BERT-Networks to the indexing reward function. On the whole, IndexKG is a general framework compatible with various KG models.

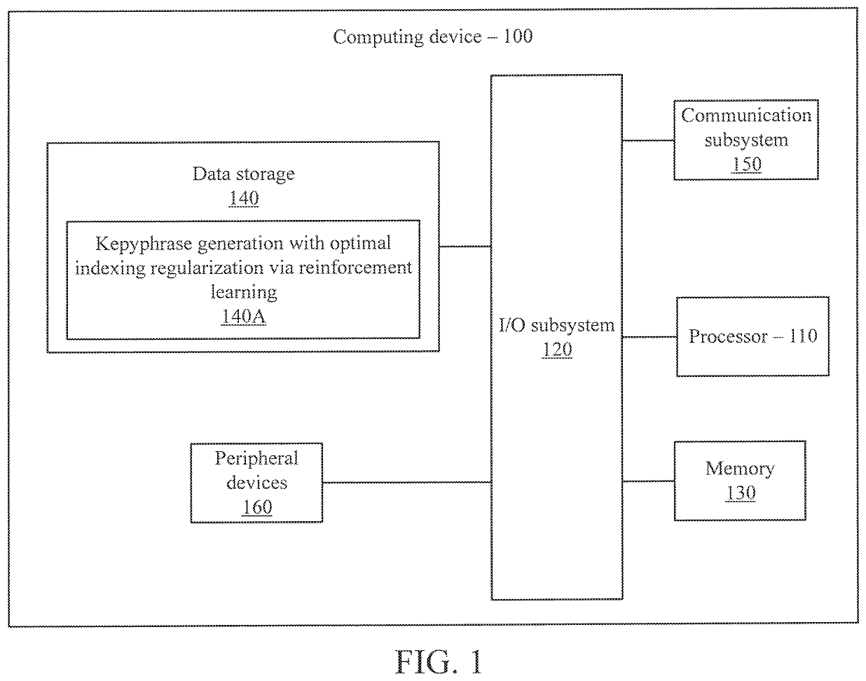

FIG. 1 is a block diagram showing an exemplary computing device 100, in accordance with an embodiment of the present invention. The computing device 100 is configured to perform keyphrase generation for text search with optimal indexing regularization via reinforcement learning.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for keyphrase generation for text search with optimal indexing regularization via reinforcement learning. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

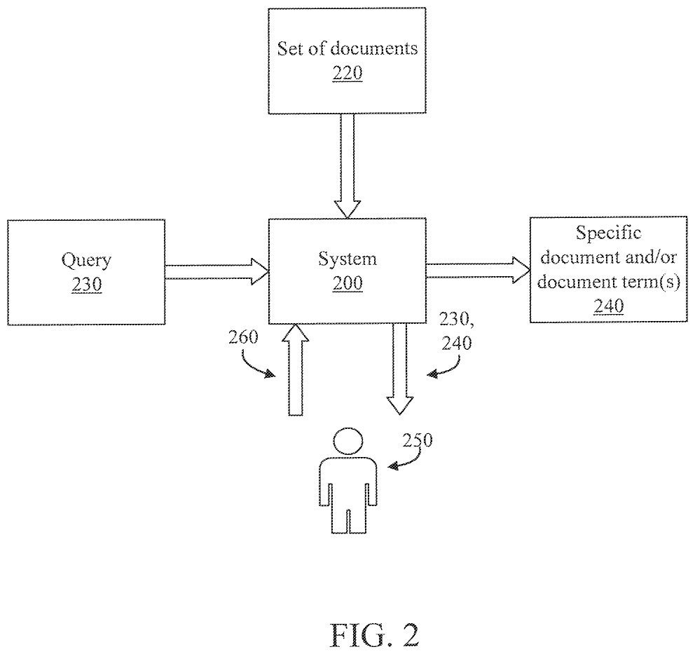

FIG. 2 is a block diagram showing an exemplary system pipeline 200, in accordance with an embodiment of the present invention.

The system 210 receives a set of documents 220, and a query 230 directed to the set of documents 220, and returns a document(s) and/or term(s) 240 in the set of documents 220 found responsive to the query 230.

A human 250 in the loop receives the query 230 and the document(s) and/or term(s) 240 found responsive to the query 230, and provides feedback 260 relating to whether the term 240 is actually responsive to the query 230.

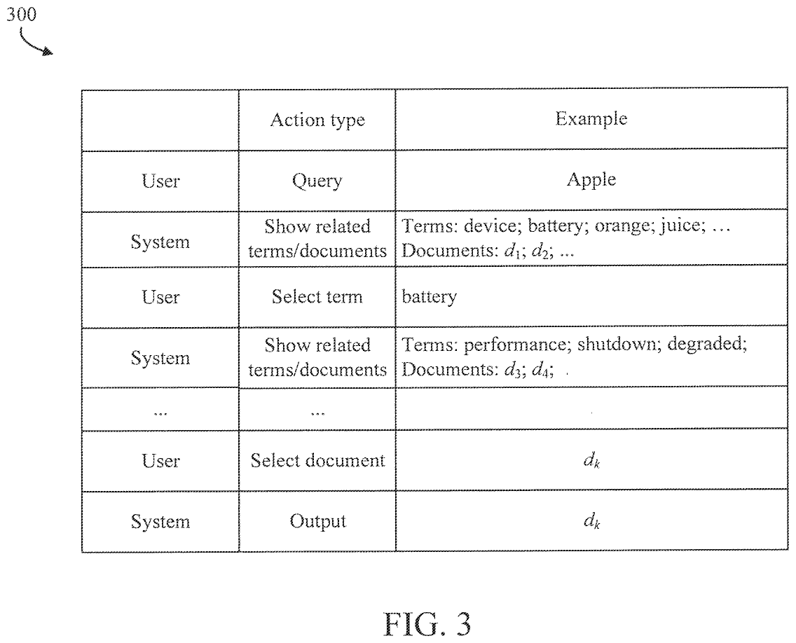

FIG. 3 is a table 300 showing an exemplary use case in which a user input a query “apple” and the system returns certain terms, in accordance with an embodiment of the present invention.

The user first inputs a query “apple”, and the system shows related terms and documents.

For example, the terms “device”, “battery”, “orange”, “juice”, and so forth are returned for the query “apple”, as well as documents d₁, d₂, . . . .

The user may then select the term “battery”, in which case the terms “performance”, “shutdown”, “degraded”, and so forth are returned, as well as documents d₃, d₄, . . . .

Further selections by the user can be made.

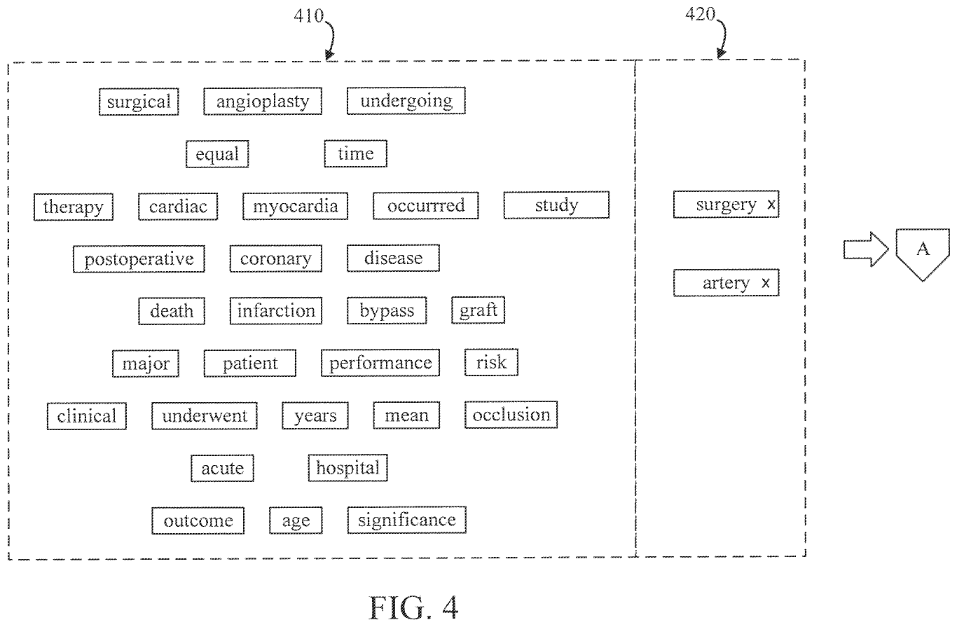

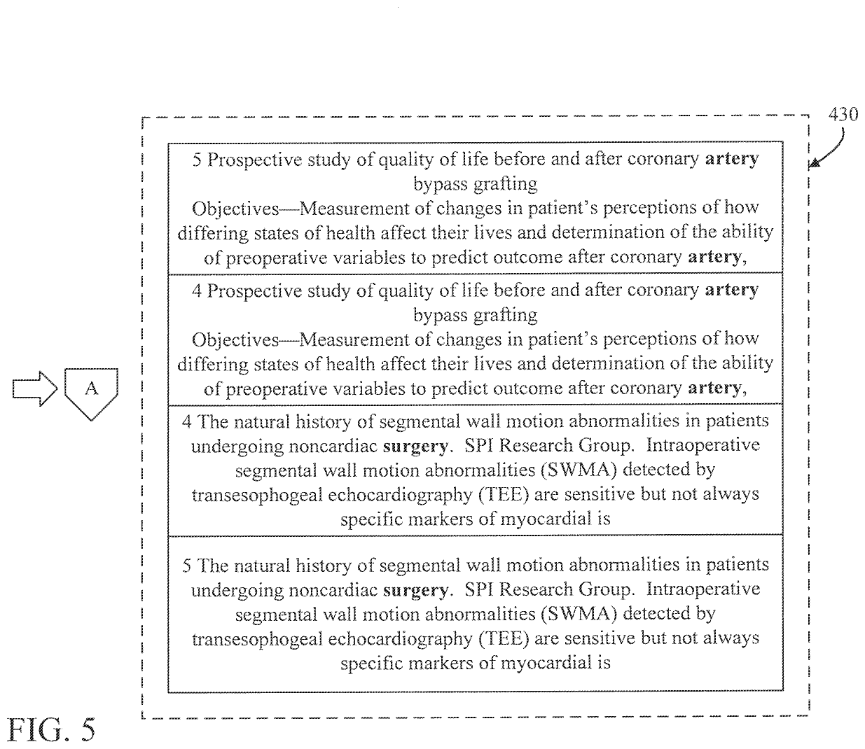

FIGS. 4-5 are diagrams showing an exemplary user interface 400, in accordance with an embodiment of the present invention.

The user interface 400 includes three parts, namely a left part 410, a middle part 420, and a right part 430. The left part 410 of the user interface 400 includes all terms the user already input so far. The middle part 420 of the user interface 400 includes the latest terms the user has input for the latest query. The right part 430 of the user interface 400 shows the documents ranking according to the relevance to the latest query posed by the user (that include one of more of the input terms). The terms included in the middle part 420 are bolded in the right part 430 to show where they occur in the document.

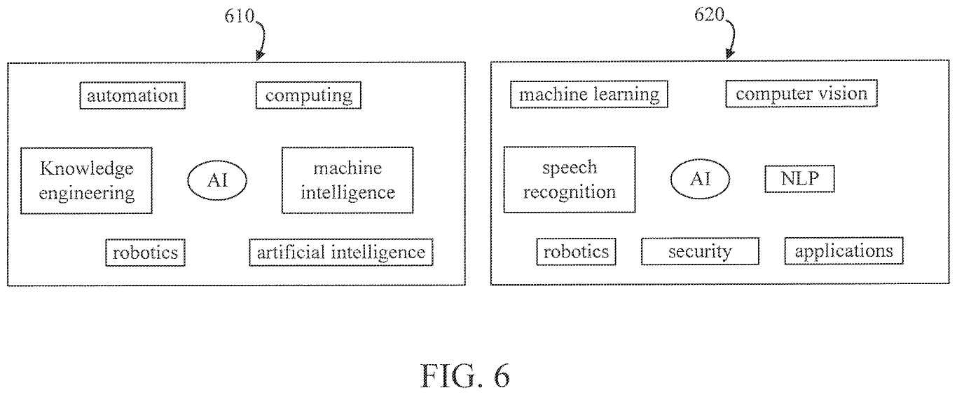

FIG. 6 is a diagram showing exemplary suggested terms for a given query “AI”, in accordance with an embodiment of the present invention.

In the left part 610, relevant words are provided that will give user a hint to further refine their search intention. How to make the suggested “terms” (i.e., surrounding terms) more informative to express potential diverse exploring aspects? Intuitively, it is better if the visualized surrounding tokens are more distinctive and representative to summarize documents. For example, as shown in FIG. 6, the suggested terms for query “AI” are shown in two different ways. The left part 610 is not a good solution, while the right part 620 is much better to help a user to navigate to his potential search intention. Since the left part visualizes many related terms that has similar meaning as the search query, thus they are less informative. The right part visualize more related but different aspects of the query term, thus they are more informative for users to further refine his search intention.

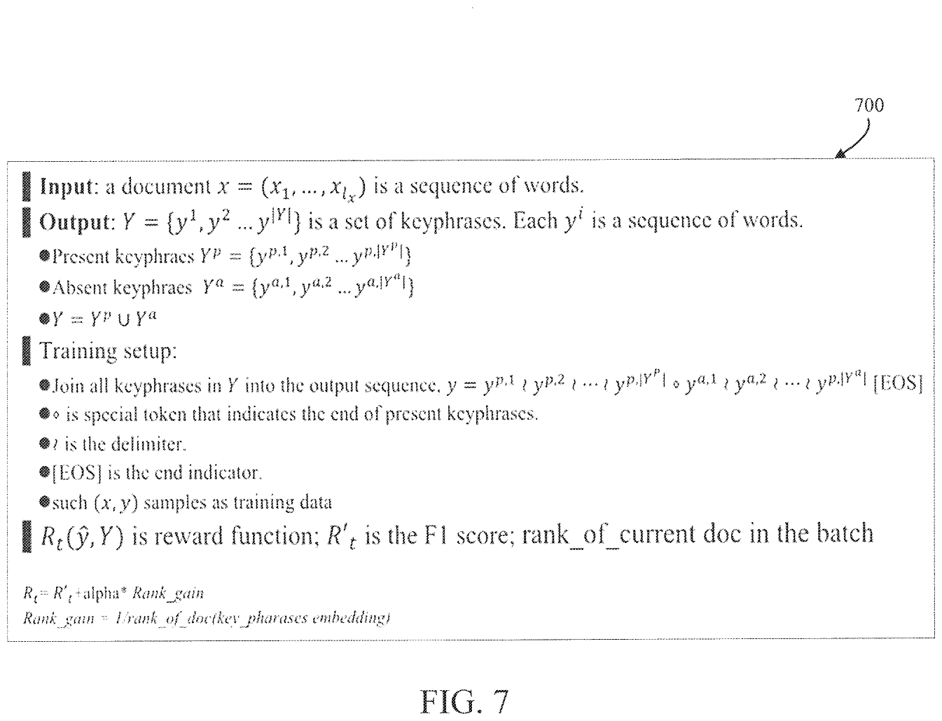

FIG. 7 is a diagram showing an exemplary Keyphrase Generation (KG) algorithm 700, in accordance with an embodiment of the present invention.

The input to the KG algorithm is a document x denoted by (x₁, . . . , xₗ_{ₓ}), which is a sequence of words. The output of the KG algorithm Y={y¹, y² . . . y^{|Y|}} is a set of keyphrases. Each yⁱ is a sequence of words. There are two kinds of annotated keyphrases, present and absent ones. The present ones,

$${Y}^{p} = \{ {y}^{p , 1} , {y}^{p , 2} … {y}^{p , \vert {Y}^{p} \vert} \} ,$$

are those that show up in the input document, while the absent ones, Y^{a}={y^{a,1}, y^{a,2} . . . y^{a,|Y}^{^{a}}^{|}}, are not included in the input document but are semantically describing the concept of the input document. Here, we have Y=Y^{p}∪Y^{a}. a denotes absent” and means the annotated keyphrase is not shown in the original document. p denotes “present” and means the keyphrase is included in the document. Absent keyphrases are inferred by the model since the model will understand the language by training with all the documents. A keyphrase although not shown in the current document, may show in other documents in the training set that have similar meaning as the current document.

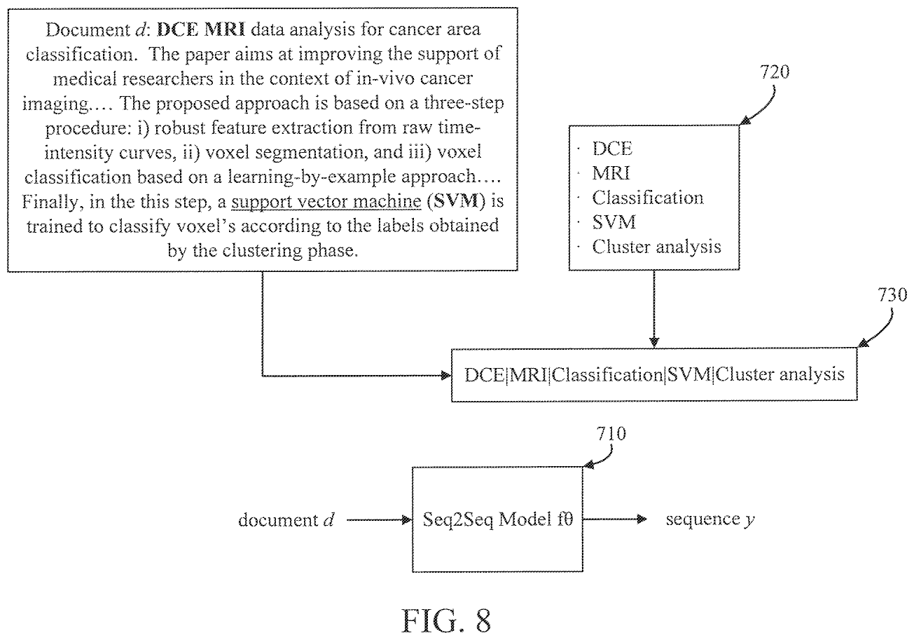

FIG. 8 is a block diagram showing an exemplary keyphrase generation 800 from a document, in accordance with an embodiment of the present invention.

The keyphrase generation 800 involves a Seq2Seq model f_{θ} 810, a set of keyphrases K 820, and a concatenation step 830 that concatenates the keyphrases in the set K 820.

The Seq2Seq model f_{θ} 810 receives a document d, and outputs a sequence y responsive to the document d.

The set of keyphrases k 820 including DCE, MRI, Classification, SVM, and Cluster analysis is concatenated to be: DCE|MRI|Classification|SVM|Cluster analysis.

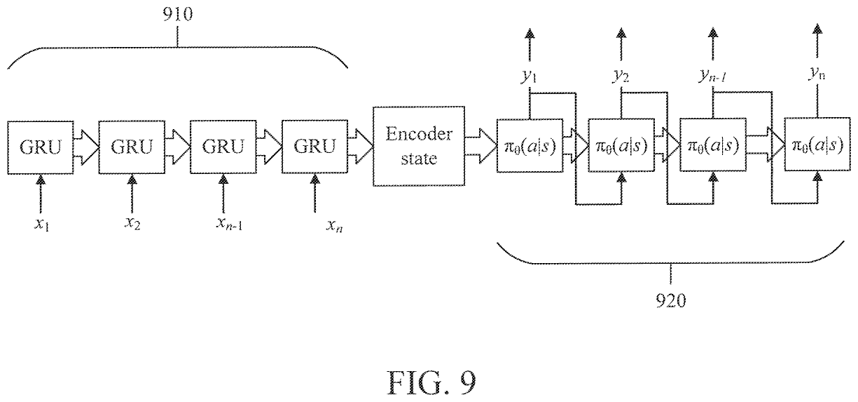

FIG. 9 is a block diagram showing an exemplary encoder-decoder learning framework 900, in accordance with an embodiment of the present invention.

The input document is first encoded by an encoder 910, as shown in FIG. 9. In the embodiment, the encoder 910 is implemented using a set of Gated Recurrent Units (GRU's). In other embodiments, the encoder 910 can be implemented by other structures such as Long Short-Term Memories (LSTMs) and/or Bidirectional Encoder Representations from Transformers (BERT). The encoded state s is used to learn the policy network π_{θ} (a|s) by a decoder 920. In the embodiment, the decoder 920 is implemented using one layer Gated Recurrent Units (GRU's) or LSTMs. In other embodiments, the decoder 920 can be implemented by other structures such as Long Short-Term Memories (LSTMs). Here, action a is to predict one token in the dictionary or the special token. For example, ⋄ is a special token that indicates the end of present keyphrases. [symbol] is the delimiter of different keyphrases. [EOS] is the end generation. The problem becomes a Seq2Seq problem that generates y from d as shown in FIG. 8.

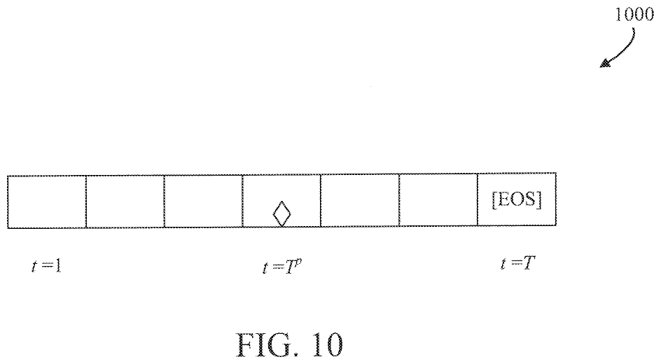

FIG. 10 is a block diagram showing an exemplary keyphrase generation procedure 1000, in accordance with an embodiment of the present invention.

The procedure 1000 separates the process into two stages. It will first generate present keyphrases before the agent generates the ⋄ token. t=[1 . . . T^{p}]. Then it generates absent keyphrases t=[T^{p}+1 . . . T] and then generates [EOS] to stop the generation. The policy network is decoder π(ŷₜ|, ŷ_{1:t-1}, x;θ), which is a neural network parameterized with θ. The reward function rₜ(ŷ_{1:t}, Y) compares the generated phrases with ground-truth. The reward function is as follows:

Rₜ=R′ₜ+alpha*Rank_gain. (1)

Here R′ₜ is the F1 score of generated keyphrases compared with the ground-truth. Rank_gain=1/rank_of_doc is the rank of that document when using the embedding of key_phrases as the query to search of documents in the batch. New state transition is calculated by ŝₜ₊₁=GRU(eₜ₋₁, sₜ₋₁), where eₜ₋₁ is the embedding of the (t−1)-th predicted word, and alpha is tunable hyper parameter.

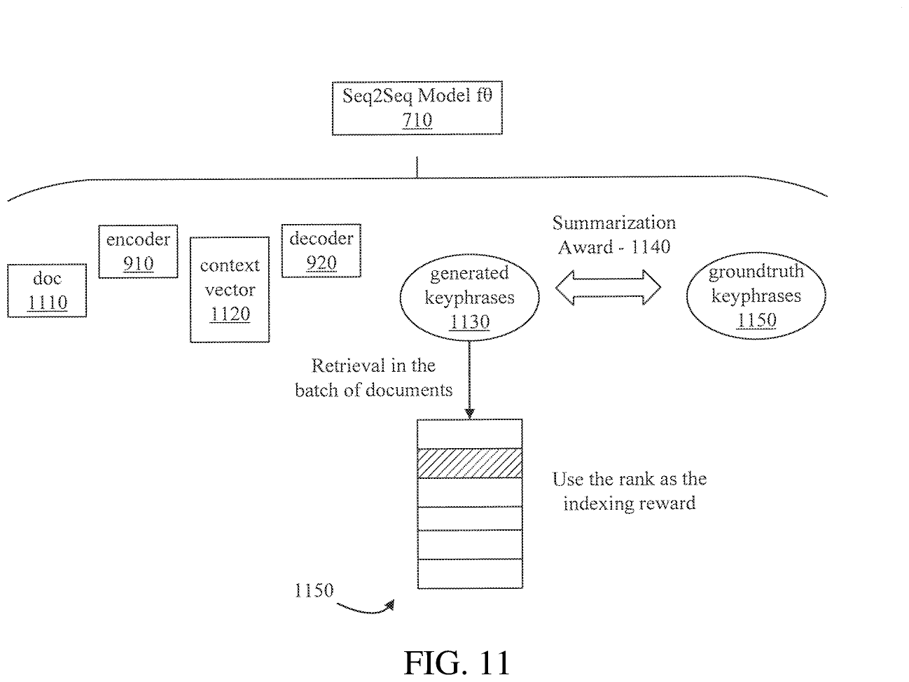

FIG. 11 is a block diagram showing an exemplary index keyphrase generation framework 1100, in accordance with an embodiment of the present invention.

The keyphrase generation framework (or “generator” in short) 1100 includes and/or otherwise involves a document 1110, an encoder 910, a context vector 1120, a decoder 920, generated keyphrases 1130, a summarization reward 1140, groundtruth keyphrases 1140, and a batch of documents 1150. The encoder 910 can be any sequence embedding framework, such as a Long Short-Term Memory (LSTM) or transformer that is able to encode a sequence of words into a vector representation. The context vector 1120 is the embedding of the previous sequence used for embedding the next token in sequence-to-sequence embedding. The decoder 920 can be any sequence generator such as a LSTM or transformer. The summarization reward includes two parts. One part is the matching F1-score (including both precision and recall) according to the ground-truth 1140. Another part comes from the ranking of the training document. We use the embedding vector of the training document's generated keyphrases to conduct a similarity search on the embeddings of documents in the batch. The rank value of the current training doc in the ranked list is used to generate the ranking reward, i.e., Rank_gain=1/rank_of_doc. Thus, it will be encouraging the generated keyphrases to uniquely index the corresponding document.

The generator 1100 will read a document 1110 and generate a sequence of words or symbols such as “;” meaning the end of one phrase or “EOS” meaning the end of generation. The generated keyphrases 1130 will be matched to the ground-truth label 1140 to get the loss, this loss together with the index reward will generate the summarization reward for training the generator's model parameter. The index reward will make the current document top-ranked by querying its keyphrases.

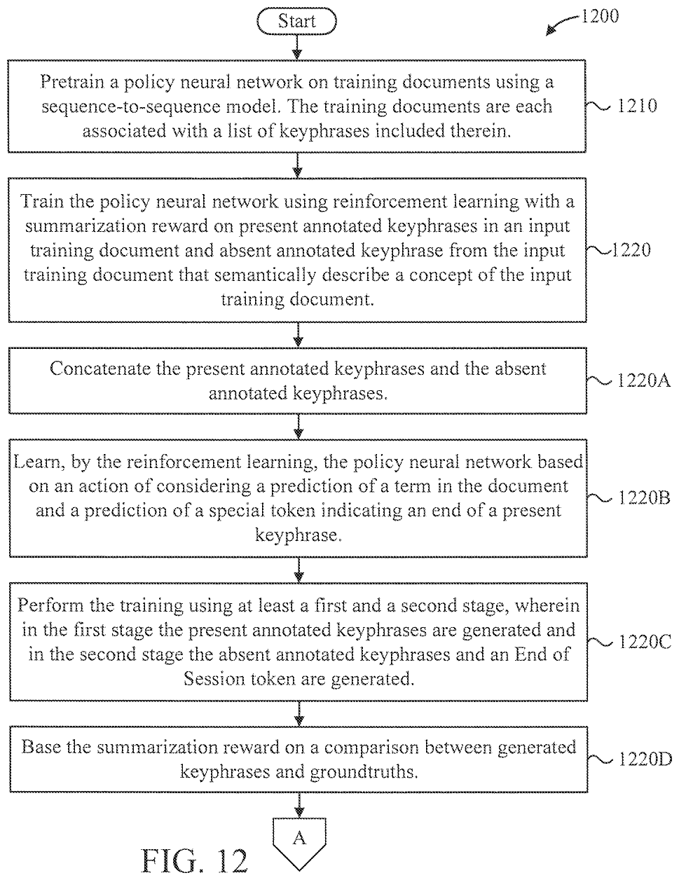

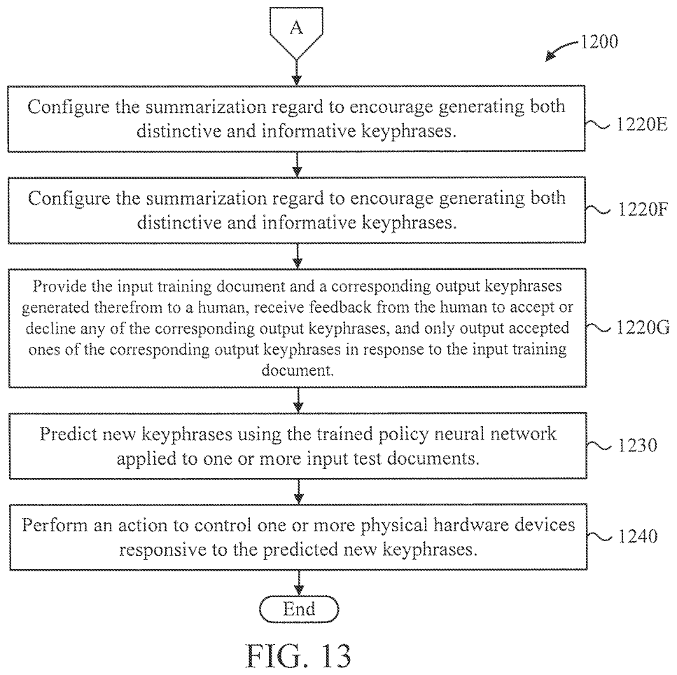

FIGS. 12-13 are flow diagrams showing an exemplary method for keyphrase generation, in accordance with an embodiment of the present invention.

At block 1210, pretrain a policy neural network on training documents using a sequence-to-sequence model. The training documents are each associated with a list of keyphrases included therein.

At block 1220, train the policy neural network using reinforcement learning with a summarization reward on present annotated keyphrases in an input training document and absent annotated keyphrase from the input training document that semantically describe a concept of the input training document. The generation framework will read a document and generate a sequence of words or symbols such as “;” meaning the end of one phrase or “EOS” meaning the end of generation. The generated keyphrases will be matched to the ground-truth label to get the loss. This loss, together with the index reward, will generate the summarization reward for training the generator's model parameter. The index reward will make the current document the top-ranked by querying its keyphrases. Since the match between generated phrases and the ground-truth is a value that is not differentiable to the model parameters, thus here we use the policy gradient in Reinforcement learning to train the model parameters.

In an embodiment, block 1220 includes one or more of blocks 1220A through 1220G.

At block 1220A, concatenate the present annotated keyphrases and the absent annotated keyphrases.

At block 1220B, learn, by the reinforcement learning, the policy neural network based on an action of considering a prediction of a term in the document and a prediction of a special token indicating an end of a present keyphrase.

At block 1220C, perform the training using at least a first and a second stage, wherein in the first stage the present annotated keyphrases are generated and in the second stage the absent annotated keyphrases and an End of Session token are generated.

At block 1220D, base the summarization reward on a comparison between generated keyphrases and groundtruths.

At block 1220E, configure the summarization regard to encourage generating both distinctive and informative keyphrases.

At block 1220F, configure the summarization reward to be used for learning recessive linguistic patterns between predicted keyphrases and the input training document.

At block 1220G, provide the input training document and a corresponding output keyphrases generated therefrom to a human, receive feedback from the human to accept or decline any of the corresponding output keyphrases, and only output accepted ones of the corresponding output keyphrases in response to the input training document.

At block 1230, predict new keyphrases using the trained policy neural network applied to one or more input test documents.

At block 1240, perform an action to control one or more physical hardware devices responsive to the predicted new keyphrases. For example, in the case an input test document represents time series data for sensors of physical machinery operating in an assembly and/or manufacturing plant, the action can be control of the physical machinery such as stopping it or slowing it down to a safe speed if it presents a dangerous condition. Other actions can also be performed as readily appreciated by one of ordinary skill in the art. The item can be a physical machine at a plant, a motor vehicle, and so forth.

In another embodiment, the action can be automatically purchasing one or more items responsive to the generated keyphrases.

In yet another embodiment, the action can be the retrieval of related documents having the keyphrases occurring therein for deeper research or other purposes.

For example, when we want to search “self-supervised learning”, however the user at the very beginning does not know such search phrase. He only knows “machine learning”. He can first input this to the system. Then the system will give feedbacks on “unsupervised learning”, “supervised learning”, and “semi-supervised learning”. The user can select “unsupervised learning”, and the system further suggests “self-supervised learning”. Then the user exactly knows what exactly he is intending to search.

Some exemplary applications to which keyphrase generation can be applied include, but are not limited to, document clustering, document summarization, Information Retrieval (IR) systems, document indexing, web mining, search engines, query refinement, web logs, recommender systems, opinion mining, relevance feedback, ontology, information extraction, named entity extraction, and topic analysis.

In an embodiment, each of the documents can represent a report of the operational status (e.g., physical operating parameters such as, e.g., speed) of a physical hardware machine such as a workplace machine (CNC, laser jet, robot, etc.). An action cab be performed responsive the keyphrases generated from the document, which could indicate an impending failure and thus the action can be shutting down the machine, slowing down the machine, e.g., to a safer operational speed, adding more water for lubricity when cutting, and so forth.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for keyphrase generation, comprising:
pretraining, by a processor device, a policy neural network on training documents using a sequence-to-sequence model, the training documents each associated with a list of keyphrases included therein;
training, by the processor device, the policy neural network using reinforcement learning with a summarization reward on present annotated keyphrases in an input training document and absent annotated keyphrase from the input training document that semantically describe a concept of the input training document; and
predicting, by the processor device, new keyphrases using the trained policy neural network.

2. The computer-implemented method of claim 1, wherein said training step comprising concatenating the present annotated keyphrases and the absent annotated keyphrases.

3. The computer-implemented method of claim 1, wherein the reinforcement learning learns the policy neural network based on an action of considering a prediction of a term in the document and a prediction of a special token indicating an end of a present keyphrase.

4. The computer-implemented method of claim 1, wherein said training step is performed using at least a first and a second stage, wherein in the first stage the present annotated keyphrases are generated and in the second stage the absent annotated keyphrases and an End of Session token are generated.

5. The computer-implemented method of claim 1, wherein the summarization reward is based on a comparison between generated keyphrases and groundtruths.

6. The computer-implemented method of claim 1, wherein the summarization regard encourages generating both distinctive and informative keyphrases.

7. The computer-implemented method of claim 1, wherein the summarization reward is configured to be used for learning recessive linguistic patterns between predicted keyphrases and the input training document.

8. The computer-implemented method of claim 1, further comprising:
providing the input training document and a corresponding output keyphrases generated therefrom to a human;
receiving feedback from the human to accept or decline any of the corresponding output keyphrases; and
only outputting accepted ones of the corresponding output keyphrases in response to the input training document.

9. The computer-implemented method of claim 1, wherein the sequence-to-sequence model comprises an encoder and a decoder, the encoder and the decoder each comprise a respective element selected from the group consisting of a Long Short Term Memory and a Gated Recurrent unit.

10. A computer program product for keyphrase generation, the computer program product comprising a non-transitory computer readable storage medium having program instructions embodied therewith, the program instructions executable by a computer to cause the computer to perform a method comprising:
pretraining, by a processor device of the computer, a policy neural network on training documents using a sequence-to-sequence model, the training documents each associated with a list of keyphrases included therein;
training, by the processor device, the policy neural network using reinforcement learning with a summarization reward on present annotated keyphrases in an input training document and absent annotated keyphrase from the input training document that semantically describe a concept of the input training document; and
predicting, by the processor device, new keyphrases using the trained policy neural network.

11. The computer program product of claim 10, wherein said training step comprising concatenating the present annotated keyphrases and the absent annotated keyphrases.

12. The computer program product of claim 10, wherein the reinforcement learning learns the policy neural network based on an action of considering a prediction of a term in the document and a prediction of a special token indicating an end of a present keyphrase.

13. The computer program product of claim 10, wherein said training step is performed using at least a first and a second stage, wherein in the first stage the present annotated keyphrases are generated and in the second stage the absent annotated keyphrases and an End of Session token are generated.

14. The computer program product of claim 10, wherein the summarization reward is based on a comparison between generated keyphrases and groundtruths.

15. The computer program product of claim 10, wherein the summarization regard encourages generating both distinctive and informative keyphrases.

16. The computer program product of claim 10, wherein the summarization reward is configured to be used for learning recessive linguistic patterns between predicted keyphrases and the input training document.

17. The computer program product of claim 10, further comprising:
providing the input training document and a corresponding output keyphrases generated therefrom to a human;
receiving feedback from the human to accept or decline any of the corresponding output keyphrases; and
only outputting accepted ones of the corresponding output keyphrases in response to the input training document.

18. A computer processing system for keyphrase generation, comprising:
a memory device for storing program code; and
a processor device, operatively coupled to the memory device, for running the program code to:
pretrain a policy neural network on training documents using a sequence-to-sequence model, the training documents each associated with a list of keyphrases included therein;
train the policy neural network using reinforcement learning with a summarization reward on present annotated keyphrases in an input training document and absent annotated keyphrase from the input training document that semantically describe a concept of the input training document; and
predict new keyphrases using the trained policy neural network.

19. The computer processing system of claim 18, wherein said processor device performs the training by concatenating the present annotated keyphrases and the absent annotated keyphrases.

20. The computer processing system of claim 18, wherein the reinforcement learning learns the policy neural network based on an action of considering a prediction of a term in the document and a prediction of a special token indicating an end of a present keyphrase.
